(19) United States
(12) Patent Application Publication
(10) Pub. No.: US 2012/0275185 A1
(43) Pub. Date: Nov. 1, 2012

(54) ILLUMINATOR

(75) Inventors: Takashi EDAMITSU, Kitasaku-gun (JP); Shun KATOH, Kitasaku-gun (JP)

(73) Assignee: MINEBEA CO., LTD., Kitasaku-gun (JP)

(21) Appl. No.: 13/426,173

(22) Filed: Mar. 21, 2012

(30) Foreign Application Priority Data
Apr. 26, 2011 (JP) 2011-098128

(51) Int. Cl. F21V 8/00; F21V 5/00

(52) U.S. Cl. 362/606; 362/311.01

(57) ABSTRACT

An illuminator includes a light source unit having an emitting surface for emitting light, and a light distribution control member having a prism surface including a plurality of prisms that have inclined surfaces and are arranged in a plane for two-dimensionally controlling light distribution of light emitted from the light source unit, wherein the prism surface has flat parts. With the light distribution control member, in the light distribution properties of the illumination light of the illuminator, the luminous intensity angular distribution is properly adjusted to have uniform illuminance distributions.

### BACKGROUND OF THE INVENTION

1. Field of the Invention The present invention is related to an illuminator, especially to an illuminator that improves illuminant uniformity on a surface to be irradiated.

2. Description of the Related Art

An illuminator generally obtains light distribution properties in which luminous intensity will be the greatest at the front face of a light emitting surface thereof while luminous intensity will decrease as an angle from the front face increases. In the illuminator with such light distribution properties, there has been a problem in that illuminance on a surface to be irradiated (a floor surface, for example, when this illuminator is attached to a ceiling as an indoor lighting), the surface being at a distance from the illuminator, is high at a portion only directly below the illuminator, and rapidly decreases moving toward the periphery. Conventionally, in order to avoid this problem and achieve a uniform illuminance at a comparatively wide area on the surface, it has been known that the light distribution properties of the illuminator are configured to be in a batwing manner to be explained hereinbelow.

FIG. 10A shows a configuration that an illuminator 100 is attached to a ceiling 102 so as to illuminate a floor surface 104 in an indoor space 106. Further, FIG. 10B is a drawing showing luminous intensity distributions (hereinafter referred to as the “luminous intensity angular distributions”) L1 and L2 of the illuminator 100 relative to a deflection angle (hereinafter referred to as the “light distribution angle”) θ from an optical axis q at one transect (for example, Po) including a reference axis (normally the central axis in the front direction of the light emitting surface; hereinafter referred to as the “optical axis”) of the light distribution properties of the illuminator 100. FIG. 10C is a drawing showing illuminance distributions (hereinafter referred to as the “illuminance angular distributions”) E1 and E2 on the floor surface 104 corresponding to each of the luminous intensity angular distributions L1 and L2 shown in FIG. 10B. In FIGS. 10B and 10C, numerical values (−90 to 90) shown along the perimeter of a circle represent the light distribution angle θ, and the luminous intensity at each light distribution angle θ is shown as a relative value wherein the angle value of the highest luminous intensity is 1. The illuminance is also shown as a relative value wherein the illuminance on the optical axis q (in other words, when θ=0°) is 1.

The luminous intensity angular distribution L2 shown in FIG. 10B corresponds to the general light distribution properties that have been discussed above. In this case, the luminous intensity of the planar illuminator 100 reaches a maximum at the direction of θ=0°, and decreases as the absolute value of the light distribution angle θ increases. Here, the illuminance on the floor surface 104 rapidly decreases as the absolute value of the light distribution angle θ increases (even though the luminous intensity angular distribution L2 is relatively uniform in the range of −25° to 25°), as can be understood from the corresponding illuminance angular distribution E2 shown in FIG. 10C.

On the other hand, if the illuminance on the floor surface 104 should be made uniform across a relatively wide area (for example, the range of −25° to 25°) as shown by the illuminance angular distribution E1 shown in FIG. 10C, it is necessary to configure the light distribution properties of the illuminator 100 as that the luminous intensity increases from the direction of θ=0° toward the directions of an upper and lower limit value (for example, ±25°) of the light distribution angle corresponding to the area as shown by the luminous intensity angular distribution L1 shown in FIG. 10B. In this case, the luminous intensity angular distribution has a bimodal distribution profile which has peak values at the upper and lower limit values of the light distribution angle θ, and light distribution properties having such a luminous intensity angular distribution are referred to as batwing light distribution properties.

Conventionally, an illuminator which includes a light distribution control member for configuring the light distribution properties in a batwing manner (see, for example, Japanese Patent Application Laid-Open No. 2009-266521) has been proposed. The illuminator disclosed in the reference will be explained hereinbelow with reference to FIG. 11.

An illuminator 200 shown in FIG. 11A includes a light source 202, and a light distribution control member 203 that controls a light distribution mode of a light L emitted from the light source 202. The light distribution control member 203 includes a three-sided pyramid prism plate 231, and this prism plate 231 is intended to disperse the light L from the light source 202 in a batwing manner. The three-sided pyramid prism plate 231 is constituted and arranged so that its light source 202 side is a flat surface 231a and the surface on the other side is a light dispersing surface 231b. The light dispersing surface 231b consists of a plurality of three-sided pyramid prisms arranged with no space in between as shown in FIG. 11B.

### SUMMARY OF THE INVENTION

However, in an illuminator, in order to further improve the uniformity of illuminance on the surface to be irradiated, it is necessary to further finely adjust the distribution profile of luminous intensity angular distributions in batwing light distribution properties. In addition, in order to improve the uniformity of illuminance on the surface to be irradiated, the light distribution properties of the illuminator should preferably be uniform in a direction around the optical axis (that is, the direction at an azimuth angle φ shown in FIG. 10A). In other words, the luminous intensity angular distribution on a transect Pφ should be the same wherever possible at any azimuth angle φ. However, as a result of study and examination by the present inventors, it has been discovered that it is difficult to adjust this kind of luminous intensity angular distribution and achieve uniformity in the direction of the azimuth angle φ in the conventional illuminator shown in FIG. 11.

Considering the above problem, an object of the present invention is to provide an illuminator that improves the uniformity of illuminance on a surface to be irradiated.

The embodiments of the invention described below are examples of the constitution of the present invention. In order to facilitate the understanding of the various constitutions of the present invention, the explanations below are divided into features. Each feature does not limit the technical scope of the present invention, and the technical scope of the present invention can also include constitutions in which a portion of the constituent elements in the features below are substituted or deleted, or another constituent element is added upon referring to the best modes for carrying out the invention.

An illuminator including a light source unit having an emitting surface for emitting light, and a light distribution control member having a prism surface including a plurality of prisms that have inclined surfaces and are arranged in a plane for two-dimensionally controlling light distribution of light emitted from the light source unit, wherein the prism surface has flat parts.

With this illuminator, since the prism surface of the light distribution control member has flat parts, batwing light distribution properties can be realized, and the luminous intensity angular distribution can be optionally adjusted so as to approach ideal distributions to achieve uniform illuminance at a predetermined area on a surface to be irradiated. In addition, illuminance uniformity around the optical axis at the predetermined area on the surface to be irradiated can be improved.

In the illuminator, the light distribution control member is arranged such that the prism surface is adapted to face an emitting surface of the light source unit.

With this illuminator, batwing light distribution properties can be easily realized compared to a constitution in which prisms are arranged to face the opposite side of the emitting surface of the light source unit.

In the illuminator, an inclination angle of the inclined surfaces of the prisms is greater than 42° but less than 45°, or is greater than 47° but less than 55°.

With this illuminator, batwing light distribution properties can be easily realized with the prisms made of normal optical resin materials (a refractive index of 1.45 to 1.6).

In the illuminator, the prisms are made of four-sided pyramids or four-sided truncated pyramids.

With this illuminator, it is possible to configure a surface area to be irradiated in which an approximately uniform illuminance is realized to have a rounded quadrilateral shape. Therefore, it is possible to provide a suitable illuminator for illuminating a quadrilateral surface to be irradiated (for example, the floor surface of a general indoor space).

In the illuminator, a plurality of lighting units consisting of the illuminator of the above are adjacently arranged.

With this illuminator, portions in which the illumination lights from adjacent lighting units overlap each other can be reduced, and thus a surface to be irradiated having a relatively wide surface area can be efficiently illuminated.

In the illuminator, the prisms are made of three-sided pyramids or three-sided truncated pyramids.

With this illuminator, uniformity around the optical axis of the light distribution properties of the illuminator can be improved.

In the illuminator, the prisms are made of circular cones or circular truncated cones.

With this illuminator, uniformity around the optical axis of the light distribution properties of the illuminator can be further improved.

In the illuminator, the light source unit includes a light guiding plate and light sources arranged on side edge surfaces of the light guiding plate.

This illuminator can improve illuminance uniformity on a surface to be irradiated based on the constitutions that have been described hereinabove.

### BRIEF DESCRIPTION OF THE DRAWING

FIG. 1A is a side view showing the essential parts of the illuminator according to an embodiment of the present invention and FIG. 1B is a side view showing a partial enlargement of a light distribution control member of the illuminator shown in FIG. 1A;

FIG. 2 illustrates plan views showing examples of a prism surface of the light distribution control member in an embodiment of the present invention. FIG. 2A shows an embodiment in which a plurality of prisms made of four-sided truncated pyramids are spread tightly across the prism surface, FIG. 2B shows an embodiment in which a plurality of prisms made of four-sided pyramids are arranged with gaps therebetween, and FIG. 2C shows an embodiment in which a plurality of prisms made of four-sided truncated pyramids are arranged with gaps therebetween;

FIG. 3 illustrates plan views showing other examples of the prism surface of the light distribution control member in an embodiment of the present invention. FIG. 3A shows an embodiment in which a plurality of prisms made of three-sided truncated pyramids are spread tightly across the prism surface, FIG. 3B shows an embodiment in which a plurality of prisms made of three-sided pyramids are arranged with gaps therebetween, and FIG. 3C shows an embodiment in which a plurality of prisms made of three-sided truncated pyramids are arranged with gaps therebetween;

FIG. 4 illustrates side cross-section views showing the inclined surfaces of the prism surface of the light distribution control member in an embodiment of the present invention. FIG. 4A corresponds to a cross-section along line A-A in FIGS. 2A and 3A, FIG. 4B corresponds to a cross-section along line B-B in FIGS. 2B and 3B, and FIG. 4C corresponds to a cross-section along line C-C in FIGS. 2C and 3C;

FIG. 5 is a plan view that schematically shows a further example of the prism surface of the light distribution control member in an embodiment of the present invention;

FIG. 6 is a drawing illustrating the light distribution properties of an illuminator as a luminous intensity distribution on a hemispherical surface illuminated by the illuminator placed in the center of a spherical body, and shows the case of a comparative example which does not include a light distribution control member;

FIG. 7 shows drawings illustrating the light distribution properties of an illuminator as a luminous intensity distribution on a hemispherical surface illuminated by the illuminator placed in the center of a spherical body. FIG. 7A shows the case of an embodiment of the present invention having a prism surface over which four-sided truncated pyramid prisms are spread tightly, and FIG. 7B shows the case of a comparative example including a light distribution control member having a prism surface over which four-sided pyramid prisms are spread tightly;

FIG. 8 shows drawings illustrating the light distribution properties of an illuminator as a luminous intensity distribution on a hemispherical surface illuminated by the illuminator placed in the center of a spherical body. FIG. 8A shows the case of an embodiment of the present invention having a prism surface over which three-sided truncated pyramid prisms are spread tightly, and FIG. 8B shows the case of a comparative example including a light distribution control member having a prism surface over which three-sided pyramid prisms are spread tightly;

FIG. 9 is a drawing illustrating the light distribution properties of the illuminator as a luminous intensity distribution on a hemispherical surface illuminated by the illuminator placed in the center of a spherical body, and shows the case of an embodiment of the present invention wherein circular cone prisms are arranged with gaps therebetween;

FIG. 10 is a drawing illustrating the properties of the luminous intensity angular distribution and the illuminance angular distribution of a general illuminator. FIG. 10A shows a configuration constitution of the illuminator, FIG. 10B is a graph showing examples of luminous intensity angular distributions corresponding to two different light distribution properties, and FIG. 10C is a graph showing examples of illuminance angular distributions corresponding respectively to the two luminous intensity angular distributions shown in FIG. 10B; and

FIG. 11 is a drawing illustrating one example of a conventional illuminator. FIG. 11A is a side cross-section view that schematically illustrates the illuminator, and FIG. 118 is a plan view showing the light distribution control member of the illuminator shown in FIG. 11A.

### DETAILED DESCRIPTION OF THE PREFERRED EMBODIMENTS

Embodiments of the present invention will be explained below based on the attached drawings. The drawings, which show all or part of the illuminator, are schematic views which highlight the characteristics of the present invention for explanation, and the relative dimensions of each illustrated part do not necessarily reflect the actual reduced scale.

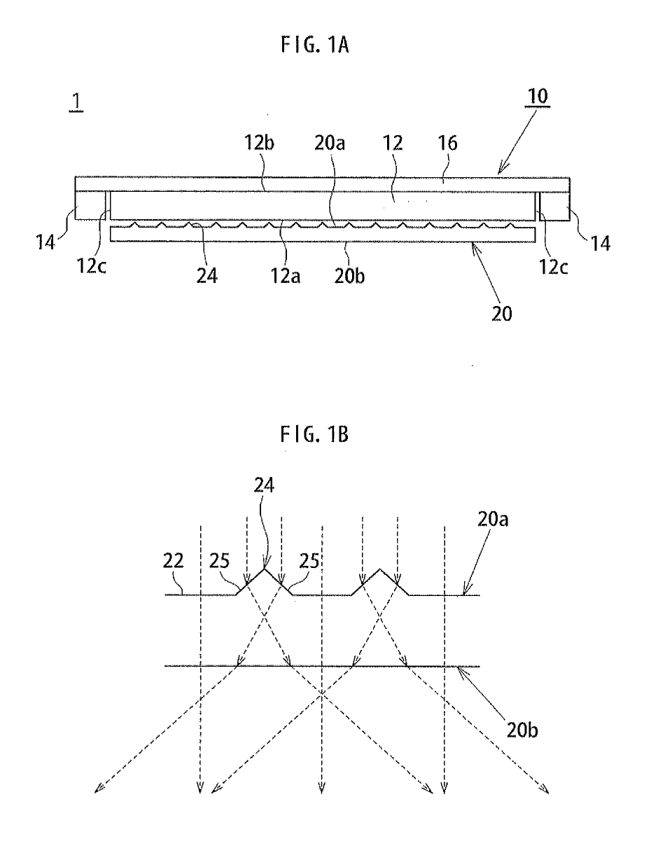

An illuminator 10 shown in FIG. 1 includes a light source unit 10 including a light guiding plate 12, light sources 14, and a reflective member 16. The light guiding plate 12 is a plate-shaped light guiding made by molding a transparent resin material such as a methacrylic resin or a polycarbonate resin. The light guiding plate 12 is constituted so that one of the principal surfaces is an emitting surface 12a, and the principal surface on the opposite side of the emitting surface 12a is a reflective surface 12b. The emitting surface 12a is the emitting surface of the light source unit 10. In the present embodiment, the light guiding plate 12 has quadrilateral principal surfaces, and the side edge surfaces on the four sides are incident light surfaces 12c. The light sources 14 are arranged facing the incident light surfaces 12c. The light sources 14 consist of, for example, a plurality of light-emitting diodes arranged along the lengthwise direction of the incident light surfaces 12c. The sheet-like reflective member 16 is disposed on the reflective surface 12b side of the light guiding plate 12 so as to cover the light guiding plate 12 and the light sources 14.

In the light source unit 10, light which has entered into the light guiding plate 12 from the light sources 14 through the incident light surfaces 12c is propagated within the light guiding plate 12 while repeating total reflection between the emitting surface 12a and the reflective surface 12b, and in this process, the propagated light is uniformly emitted from the emitting surface 12a. Further, a diffuse reflecting unit or a regular reflecting unit can be provided on the reflective surface 12b of the light guiding plate 12 to reflect a portion of the light that has entered the reflective surface 12b and cause it to enter the emitting surface 12a at an incident angle that is at or below a critical angle.

The illuminator 10 includes a light distribution control member 20 disposed on the emitting surface 12a side of the light source unit 10. The light distribution control member 20 is made by molding a transparent resin material such as a methacrylic resin or a polycarbonate resin into a plate shape, and it is formed with a shape and size to cover at least the emitting surface 12a of the light source unit 10 when disposed at a predetermined position. One of the principal surfaces of the light distribution control member 20 is configured as a prism surface 20a on which a plurality of prisms 24 having inclined surfaces 25 are provided. Further, the prism surface 20a has flat parts 22. In the light distribution control member 20 of the illuminator 10, the prism surface 20a is arranged facing the emitting surface 12a of the light source unit 10, and the principal surface on the opposite side of the prism surface 20a is configured as a flat surface 20b.

In the illuminator 10, light (shown schematically as dashed-line arrows in FIG. 1B) emitted from the emitting surface 12a of the light source unit 10 passes through the light distribution control member 20 from the prism surface 20a side toward the flat surface 20b side, and thereby the light emitted from the flat surface 20b and of which the light distribution is controlled is used as illumination light. At this time, in the illuminator 10, since the prism surface 20a of the light distribution control member 20 has the inclined surfaces 25 that constitute the prisms 24 and the flat parts 22, light that has entered the light distribution control member 20 through the inclined surfaces 25 and light that has entered the light distribution control member 20 through the flat parts 22 are mixed in the illumination light.

In the light distribution control member 20, the plurality of prisms 24 are arranged in a plane for two-dimensionally controlling the light distribution of the light emitted from the light source unit 10. Here, in the present specification, an arrangement “in a plane” means that the plurality of prisms 24 are arranged so that inclined surfaces that are inclined in at least two different directions relative to the flat parts 22 are included in the inclined surfaces 25 of the prisms 24 included on the prism surface 20a.

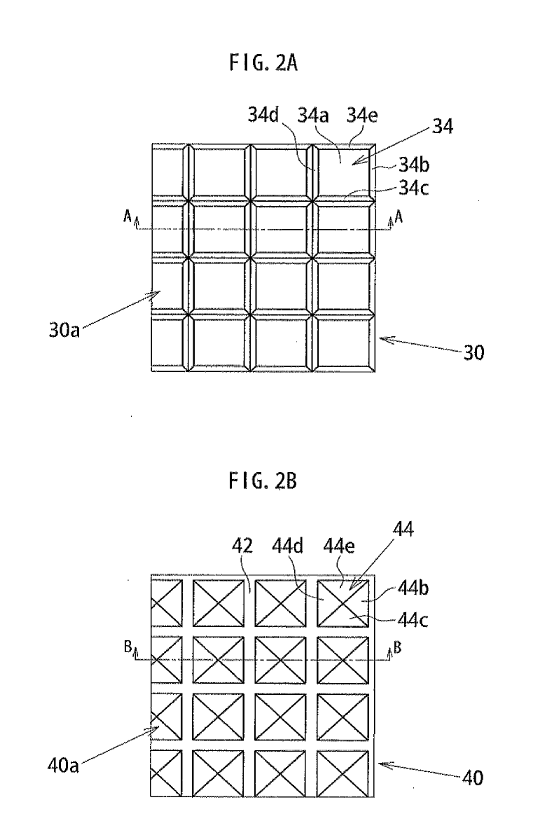

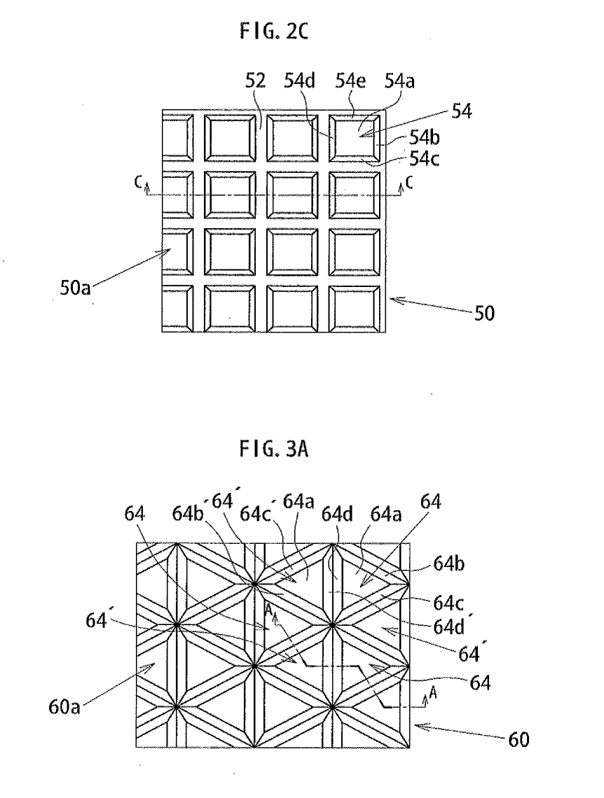

For example, the inclined surfaces 25 shown within the scope of FIG. 1 are inclined in one direction relative to the flat parts 22 (in this case, the single dimension in the left-right direction of the paper surface), but the prism surface 20a of the light distribution control member 20 actually includes inclined surfaces that are inclined in a different direction from the inclined surfaces 25 (for example, the direction orthogonal to the paper surface in FIG. 1). Next, referring to FIGS. 2 and 3, examples of the constitution and arrangement embodiment of the plurality of prisms 24 in the light distribution control member 20 in the present embodiment will be explained.

FIGS. 2A, 2B and 2C are plan views for illustrating examples of the constitution and arrangement of the light distribution control member 20 and the plurality of prisms 24 in the present embodiment, and they show a portion of light distribution control members 30, 40 and 50 when viewed respectively from the side of prism surfaces 30a, 40a and 50a.

In the light distribution control member 30 shown in FIG. 2A, the prisms 34 are made of four-sided truncated pyramids including a flat top surface 34a and four side surfaces 34b, 34c, 34d and 34e that are inclined relative to the top surface 34a. The plurality of prisms 34 are arranged tightly with each other, and each of the four sides (in the prisms 34 positioned at the outermost periphery of the prism surface 30a, the three or two sides at which adjacent prisms 34 exist) constituting the outer periphery of the base of the four-sided truncated pyramid of each prism 34 abuts one side corresponding to an adjacent prism 34.

In this arrangement embodiment, the flat parts of the prism surface 30a of the light distribution control member 30 are constituted by the top surfaces 34a of the prisms 34, and the side surfaces 34b, 34c, 34d and 34e of the prisms constitute inclined surfaces (also shown by reference numerals 34b, 34c, 34d and 34e) that are inclined relative to the flat parts (also shown by reference numeral 34a). According to this arrangement embodiment, the prism surface 30a of the light distribution control member 30 has groups of inclined surfaces that are inclined in two different directions, including the inclined surfaces 34b and 34d that are inclined in the left-right direction of the paper surface and the inclined surfaces 34c and 34e that are inclined in the up-down direction of the paper surface.

If the orientations within the two directions of the left-right direction of the paper surface and the up-down direction of the paper surface are also considered, the prism surface 30a has the following four types of inclined surfaces: the inclined surface 34d that is inclined in the right direction, the inclined surface 34b that is inclined in the left direction, the inclined surface 34e that is inclined in the downward direction and the inclined surface 34c that is inclined in the upward direction. Further, in the example shown in FIG. 2A, the prisms 34 are each constituted by a congruent four-sided truncated pyramid in which the base is a square. The inclined surfaces 34b, 34c, 34d and 34e are arranged in a pattern having four-fold rotational symmetry around the vertex of the base of each prism 34.

The light distribution control member 40 shown in FIG. 2B is different compared to the light distribution control member 30 shown in FIG. 2A in that the plurality of prisms 44 are made of four-sided pyramids including four side surfaces 44b, 44c, 44d and 44e, and the plurality of prisms 44 are arranged with gaps between adjacent prisms 44. In this arrangement embodiment, the flat parts of the prism surface 40a of the light distribution control member 40 are constituted by flat surfaces 42 formed around each prism 44, and the side surfaces 44b, 44c, 44d and 44e of the prisms constitute inclined surfaces (also shown by reference numerals 44b, 44c, 44d and 44e) that are inclined relative to the flat parts (also shown by reference numeral 42).

The light distribution control member 50 shown in FIG. 2C is the same as the light distribution control member 30 shown in FIG. 2A in that the prisms 54 are made of four-sided truncated pyramids including a flat top surface 54a and four side surfaces 54b, 54c, 54d and 54e. However, the light distribution control member 50 is different from the light distribution control member 30 in that the prisms 54 are arranged with gaps between adjacent prisms 54. In this arrangement embodiment, the flat parts of the prism surface 50a of the light distribution control member 50 are constituted by both the top surfaces 54a of each prism 54 and flat surfaces 52 formed around each prism 54, and the side surfaces 54b, 54c, 54d and 54e of the prisms constitute inclined surfaces (also shown by reference numerals 54b, 54c, 54d and 54e) that are inclined relative to the flat parts (also shown by reference numerals 54a and 52).

FIGS. 3A, 3B and 3C are plan views for illustrating examples of the constitution and arrangement of the light distribution control member 20 and the plurality of prisms 24 in the present embodiment, and they show a portion of light distribution control members 60, 70 and 80 when viewed respectively from the side of prism surfaces 60a, 70a and 80a.

In the light distribution control member 60 shown in FIG. 3A, the plurality of prisms 64 and 64′ consist of prisms 64 made of three-sided truncated pyramids including a flat top surface 64a and three side surfaces 64b, 64c, 64d and prisms 64′ made of three-sided truncated pyramids including a flat top surface 64a and three inclined surfaces 64b′, 64c′ and 64d′. The plurality of prisms 64 and 64′ are arranged tightly with each other, and each of the three sides (in the prisms 64 positioned at the outermost periphery of the prism surface 60a, the two sides or one side at which adjacent prisms 64′ exist) constituting the outer periphery of the base of the three-sided truncated pyramid of each prism 64 abuts one side corresponding to an adjacent prism 64′, and each of the three sides (in the prisms 64′ positioned at the outermost periphery of the prism surface 60a, the two sides or one side at which adjacent prisms 64 exist) constituting the outer periphery of the base of the three-sided truncated pyramid of each prism 64′ abuts one side corresponding to an adjacent prism 64.

In this arrangement embodiment, the flat parts of the prism surface 60a of the light distribution control member 60 are constituted by the top surfaces 64a of the prisms 64 and 64′, and the side surfaces 64b, 64b′, 64c, 64c′, 64d, and 64d′ of the prisms constitute inclined surfaces (also shown by reference numerals 64b, 64c, 64d, 64b′, 64c′ and 64d′) that are inclined relative to the flat parts (also shown by reference numeral 64a). According to this arrangement embodiment, the prism surface 60a of the light distribution control member 60 has groups of inclined surfaces that are inclined in three different directions, including the inclined surfaces 64b and 64b′ that are inclined in the diagonal direction running from the upper right to the lower left of the paper surface, the inclined surfaces 64c and 64c′ that are inclined in the diagonal direction running from the upper left to the lower right of the paper surface, and the inclined surfaces 64d and 64d′ that are inclined in the left-right direction of the paper surface.

If the orientations within the three directions of the diagonal direction running from the upper right to the lower left of the paper surface, the diagonal direction running from the upper left to the lower right of the paper surface, and the left-right direction of the paper surface are also considered, the prism surface 60a has the following six types of inclined surfaces: the inclined surface 64b that is inclined toward the lower left, the inclined surface 64c that is inclined toward the upper left, and the inclined surface 64d that is inclined toward the right, which constitute the side surfaces of the prisms 64, and the inclined surface 64b′ that is inclined toward the upper right, the inclined surface 64c′ that is inclined toward the lower right, and the inclined surface 64d′ that is inclined toward the left, which constitute the side surfaces of the prisms 64′. Further, in the example shown in FIG. 3A, the prisms 64 and 64′ are each constituted by a congruent three-sided truncated pyramid in which the base is an equilateral triangle. The inclined surfaces 64b, 64c, 64d, 64b′, 64c′ and 64d′ are arranged in a pattern having six-fold rotational symmetry around the vertex of the base of each prism 64 and 64′.

The light distribution control member 70 shown in FIG. 3B is different compared to the light distribution control member 60 shown in FIG. 3A in that the plurality of prisms 74 (74′) are made of three-sided pyramids including three side surfaces 74b (74b′), 74c (74c′) and 74d (74d′), and the prisms 74 (74′) are arranged with gaps between adjacent prisms 74 (74′). In this arrangement embodiment, the flat parts of the prism surface 70a of the light distribution control member 70 are constituted by flat surfaces 72 formed around each prism 74 (74′) and the side surfaces 74b, 74c, 74d, 74b′, 74c′, 74d′ of the prisms 74 and 74′ constitute inclined surfaces (also shown by reference numerals 74b, 74c, 74d, 74b′, 74c′, 74d′) that are inclined relative to the flat parts (also shown by reference numeral 72).

The light distribution control member 80 shown in FIG. 3C is the same as the light distribution control member 60 shown in FIG. 3A in that the prisms 84 (84′) are made of three-sided truncated pyramids including a flat top surface 84a and three side surfaces 84b (84b′), 84c (84c′) and 84d (84d′). However, the light distribution control member 80 is different from the light distribution control member 60 in that the prisms 84 (84′) are arranged with gaps between adjacent prisms 84 (84′). In this arrangement embodiment, the flat parts of the prism surface 80a of the light distribution control member 80 are constituted by both the top surfaces 84a of each prism 84 and 84′ and flat surfaces 82 formed around each prism 84 and 84′, and the side surfaces 84b, 84c, 84d, 84b′, 84c′ and 84d′ of the prisms 84 and 84′ constitute inclined surfaces (also shown by reference numerals 84b, 84c, 84d, 84b′, 84c′ and 84d′) that are inclined relative to the flat parts (also shown by reference numerals 84a and 82).

In these kind of light distribution control members 30, 40, 50, 60, 70, 80 and 90, the prisms 34, 44, 54, 64, 64′, 74, 74′, 84 and 84′ included on the prism surfaces 30a, 40a, 50a, 60a, 70a, 80a and 90a are formed so that their inclined surfaces 34b to 34e, 44b to 44e, 54b to 54e, 64b to 64d, 74b′ to 74d′ and 84b′ to 84d′ have inclination angles of 42° or greater and 45° or less, or 47° or greater and 55° or less.

The inclination angles of the inclined surfaces 34b to 34e, 44b to 44e, 54b to 54e, 64b to 64d, 74b′ to 74d′ and 84b′ to 84d′ refer to the acute angle among the angles formed by the inclined surfaces 34b to 34e, 44b to 44e, 54b to 54e, 64b to 64d, 74b′ to 74d′ and 84b′ to 84d′ and the corresponding flat parts 34a, 42, 54a and 52, 64a, 72 and 84a and 82 on the prism surfaces 30a, 40a, 50a, 60a, 70a, 80a and 90a.

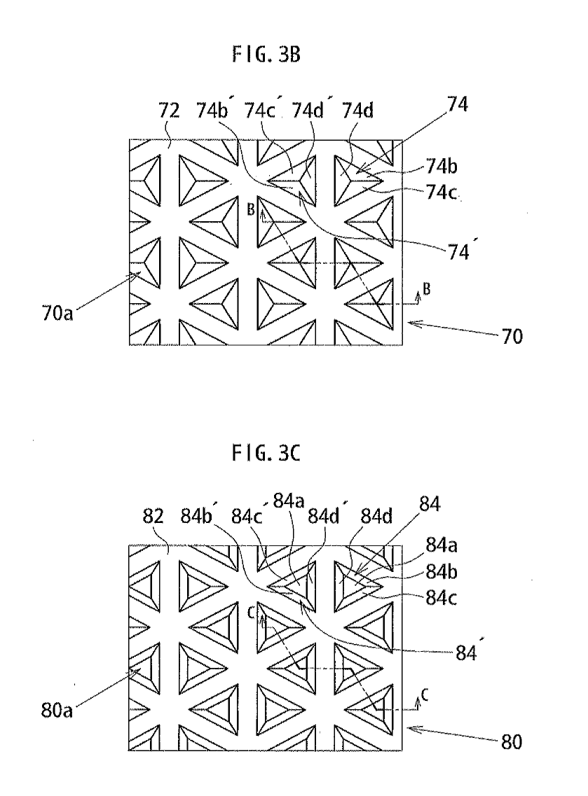

FIG. 4A (cross-section view along line A-A of FIG. 2A) shows an inclination angle α using the inclined surfaces 34b and 34d and the flat parts 34a on the prism surface 30a shown in FIG. 2A as an example, FIG. 4B (cross-section view along line B-B of FIG. 2B) shows an inclination angle α using the inclined surfaces 44b and 44d and the flat parts 42 on the prism surface 40a shown in FIG. 2B as an example, and FIG. 4C (cross-section view along line C-C of FIG. 2C) shows an inclination angle α using the inclined surfaces 54b and 54d and the flat parts 54a and 52 on the prism surface 50a shown in FIG. 2C as an example.

The profiles of the cross-sections shown in FIGS. 4A, 4B and 4C also correspond respectively to the cross-section along line A-A in FIG. 3A, the cross-section along line B-B in FIG. 3B and the cross-section along line C-C in FIG. 3C.

The constitution and arrangement embodiment of the plurality of prisms 24 in the light distribution control member 20 of the light apparatus 10 are not limited to the constitutions and arrangement embodiments of the prisms shown in FIGS. 2 to 4, as long as the plurality of prisms 24 are arranged in a plane.

For example, FIGS. 2 and 3 show examples in which the prisms are made of four-sided truncated pyramids (prisms 34 and 54), four-sided pyramids (prisms 44), three-sided truncated pyramids (prisms 64, 64′, 84 and 84′), and three-sided pyramids (prisms 74 and 74′). However, the plurality of prisms of the light distribution control member 20 can be truncated pyramids or pyramids with a base of an arbitrary polygon shape, circular truncated cones or circular cones, or an arbitrary combination of these.

In the case of prisms made of circular truncated cones or circular cones, the inclination angle of the inclined surfaces thereof is defined as the inclination angle of the tangential plane of the side surface of the circular truncated cone or circular cone.

FIGS. 2 and 3 show examples in which the prisms 34, 44, 54, 64, 64′, 74, 74′, 84 and 84′ are arranged according to a pattern having a specific symmetry. However, in the light distribution control member 20, the plurality of prisms 24 can also be arranged according to any suitable arrangement pattern (or randomly).

In addition, in the prism surfaces 30a, 40a, 50a, 60a, 70a, 80a and 90a shown in FIGS. 2 and 3, the prisms 34, 44, 54, 64, 64′, 74, 74′, 84 and 84′ are formed as convex parts that project in a direction toward the emitting surface 12a when arranged in the illuminator 10. However, the light distribution control member 20 can also include prisms formed as concave parts such that the concave/convex pattern described above is inversed.

In this case, for example, in the light distribution control member 30 shown in FIG. 2A, if the concave/convex pattern of the prism surface 30a is inversed so that all of the prisms 34 are concave parts, the resulting constitution can be regarded as a constitution in which a plurality of triangular pillar-shaped linear prisms which have two inclined surfaces corresponding to the inclined surfaces 34b and 34d and extend in the up-down direction of the paper surface, and a plurality of triangular pillar-shaped linear prisms which have two inclined surfaces corresponding to the inclined surfaces 34c and 34e and extend in the left-right direction of the paper surface are arranged to cross over each other.

Similarly, in the light distribution control member 40 shown in FIG. 3A, if the concave/convex pattern of the prism surface 40a is inversed so that all of the prisms 64 and 64′ are concave parts, the resulting constitution can be regarded as a constitution in which a plurality of triangular pillar-shaped linear prisms which have two inclined surfaces corresponding to the inclined surfaces 64b and 64b′ and extend in the diagonal direction running from the upper left to the lower right of the paper surface, a plurality of triangular pillar-shaped linear prisms which have two inclined surfaces corresponding to the inclined surfaces 64c and 64c′ and extend in the diagonal direction running from the upper right to the lower left of the paper surface, and a plurality of triangular pillar-shaped linear prisms which have the inclined surfaces 64d and 64′ and extend in the up-down direction of the paper surface are arranged to cross over each other.

In this way, the light distribution control member 20 can include a constitution in which the prisms 24 included on the prism surface 20a are configured as a plurality of triangular pillar-shaped linear prisms that are arranged in a plane.

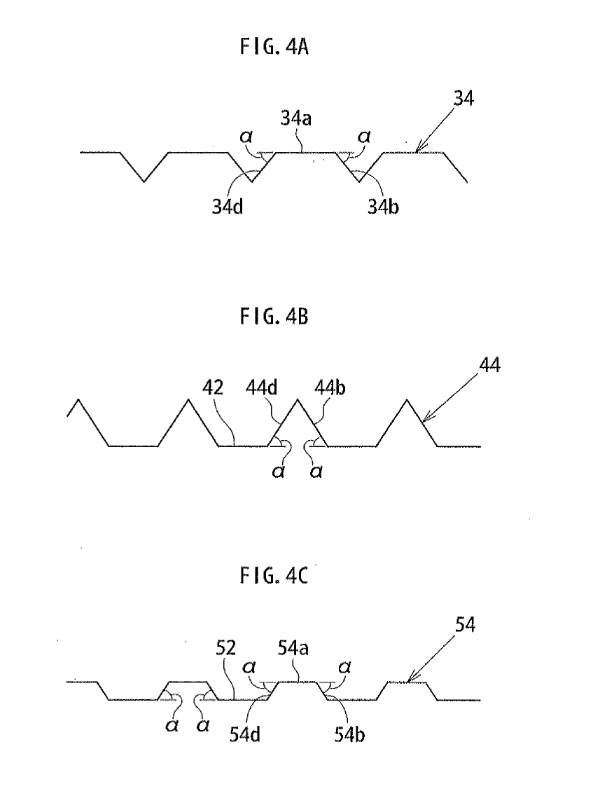

Further, the light distribution control member 20 in the present embodiment can be configured like a light distribution control member 90 shown as one example in FIG. 5, in which a prism surface 90a thereof is constituted by arranging a combination of a plurality of prism areas 91 provided with a plurality of the prisms 24 and a plurality of flat areas 92 formed as flat surfaces.

In the light distribution control member 90, the prism areas 91 can be constituted by, for example, arranging a plurality of pyramid-shaped prisms tightly across each area so that the prism areas 91 have no flat parts. In this case, the flat parts of the prism surface 90a are constituted by the plurality of flat areas 92. Alternatively, the prism areas 91 can be constituted by, for example, using a constitution like those described above referring to FIGS. 2 and 3 so that they include flat parts, and thereby the flat parts of the prism surface 90a are constituted by both the flat parts included in the plurality of prism areas 91 and the plurality of flat areas 92.

FIG. 5 shows an example in which square-shaped prism areas 91 and square-shaped flat areas 92 are arranged in a staggered lattice fashion. However, in the light distribution control member 90, the shape and arrangement constitution of the prism areas 91 and the flat areas 92 can be configured in any appropriate fashion.

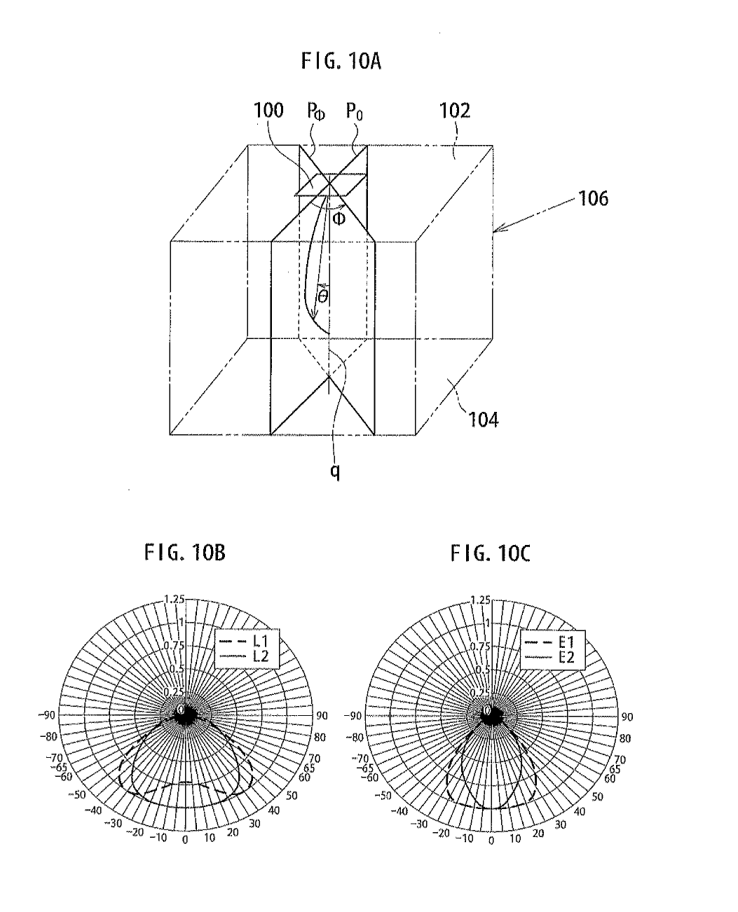

According the illuminator 10 constituted as described above, the light distribution of light emitted from the light source unit 10 can be controlled two-dimensionally, and batwing light distribution properties can be realized. Also, the luminous intensity angular distribution relative to the light distribution angle θ (refer to FIG. 10A) can be arbitrarily adjusted to approach an ideal distribution for achieving a uniform illuminance in a predetermined area on the surface to be irradiated. In addition, the uniformity around the optical axis q (refer to 10A) of the illuminance in the predetermined area on the surface to be irradiated can be improved.

In the illuminator 10 of the above-described embodiment, the light source unit 10 includes the light guiding plate 12 and the light sources 14 disposed on the incident light surfaces 12c of the light guiding plate 12. However, the light source unit in the illuminator according to the present invention is not limited to this embodiment. For example, the light source unit can be configured such that a plurality of light sources (for example, light-emitting diodes) are arranged in a flat plane without using a light guiding plate. Alternatively, the light source unit can include an organic electroluminescent element.

### Examples

The operational effects of the present invention will be explained below based on examples.

As a result of keen research, the present inventors made the following discovery regarding the ideal luminous intensity angular distribution for achieving a uniform illuminance in a predetermined area on the surface to be irradiated (hereinafter, the absolute value (for example, 25° in the illuminance angular distribution E1 shown in FIG. 10C) of the upper and lower limit values of the light distribution angle θ (refer to FIG. 10A) corresponding to the area in which uniform illuminance is to be achieved on the surface to be irradiated may also be referred to as required angle θ_{R}).

The present inventors discovered that the luminous intensity angular distribution in batwing light distribution properties must have a certain distribution profile in order to obtain an ideal illuminance uniformity, and at least, the relationship represented by A≈B cos³ θ_{R} must be satisfied between a luminous intensity A in the direction of the optical axis q (direction at light distribution angle θ=0°) and a luminous intensity B in the direction of the required angle θ_{R}.

Therefore, for example, if the required angle θ_{R} is 25°, by setting a ratio A/B (hereinafter also referred to as the relative intensity on the optical axis) of the luminous intensity A in the direction of the optical axis q to the luminous intensity B in the direction of the required angle θ_{R} to 75%, a superior uniformity can be achieved in the area on the surface to be irradiated corresponding to the range in which the light distribution angle θ is −25° to 25°.

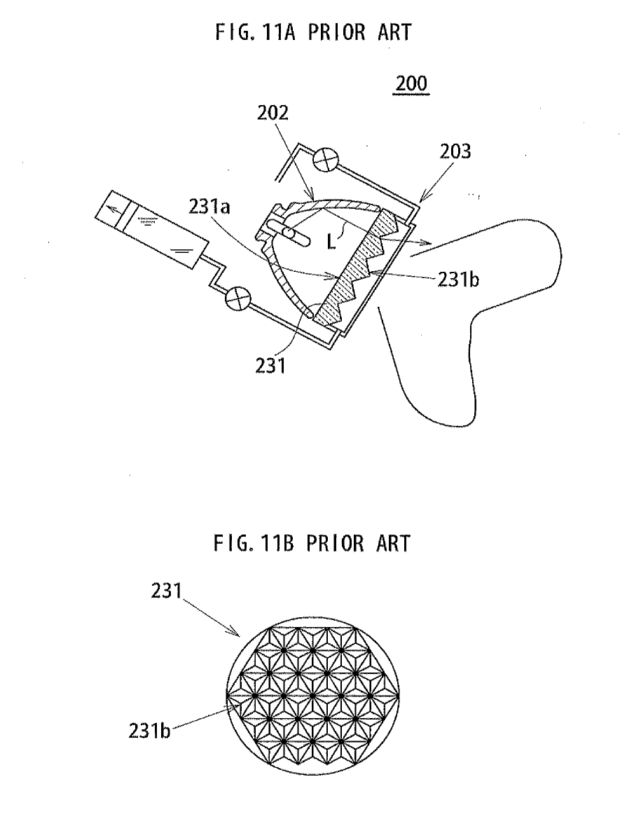

In addition, the present inventors also made the following discovery regarding an illuminator including a light source unit and a light distribution control member. Namely, as in the conventional illuminator 200 shown in FIG. 11, if the light distribution control member 231 is constituted so that the prism surface thereof (the light dispersing surface 231b) is arranged facing the opposite side of the light source 202 (a so-called ordinary prism sheet arrangement), the luminous intensity angular distribution easily takes on a unimodal or trimodal profile having a luminous intensity peak on the optical axis q, and it is actually difficult to obtain batwing light distribution properties. In contrast, the inventions found that if the light distribution control member 20 is constituted so that the prism surface 20a is arranged facing the emitting surface 12a of the light source unit 10 as in the illuminator 10 (a so-called reverse prism sheet arrangement), it is easy to obtain batwing light distribution properties having a bimodal luminous intensity angular distribution.

The present inventors also discovered that when the light distribution control member 20 is prepared using a transparent resin (a refractive index of 1.45 to 1.6) (of polycarbonate resin or methacrylic resin or the like) that is normally used as an optical material, if the inclination angle of the inclined surfaces 25 of the prisms 24 included on the prism surface 20a is smaller than 42°, larger than 45° and smaller than 47°, and larger than 55°, a trimodal luminous intensity angular distribution tends to be generated, having a short peak of luminous intensity on the optical axis q. In order to obtain light distribution properties with a batwing shape having a bimodal luminous intensity angular distribution, the inclination angle of the inclined surfaces 25 is preferably set to 42° or greater and 45° or less, or 47° or greater and 55° or less.

Below, the results of simulations regarding the light distribution properties of examples of the present invention and those of comparative examples are shown. The simulations were carried out regarding the luminous intensity angular distribution on a hemispherical surface illuminated by an illuminator, wherein the illuminator includes a light guiding plate having a square-shaped principal surface in which the length of one side is 600 mm and a light source unit having light sources disposed along the four side edge surfaces of the light guiding plate, and the illuminator is arranged in the center of a spherical body having a radius of 2 m.

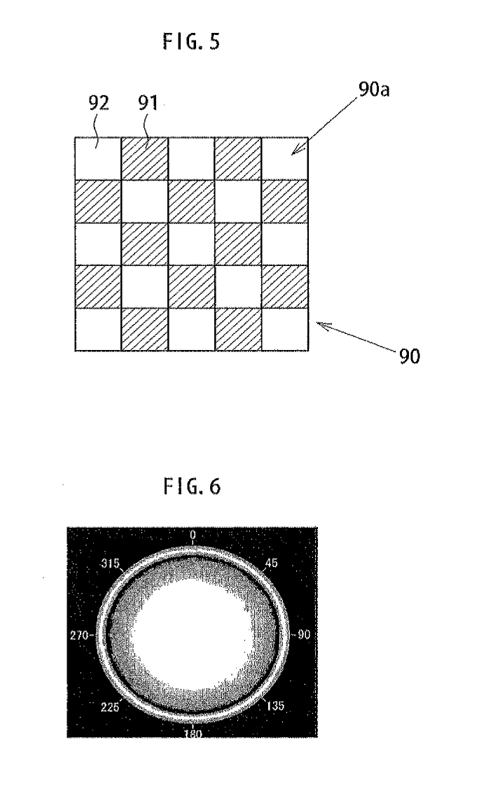

FIGS. 6 to 8 are drawings illustrating the luminous intensity distribution on the hemispherical surface as a lightness/darkness distribution within a circle corresponding to the hemispherical surface. In FIGS. 6 to 8, the center of the circle corresponds to an intersection point of the optical axis q and the hemispherical surface, and the values indicated on the periphery of the circle perimeter correspond to the azimuth angles φ around the optical axis q (refer to FIG. 10A). At each azimuth angle φ, the lightness/darkness distribution on the diameter extending from the position of the azimuth angle φ, on the circle's perimeter to the position of the azimuth angle φ+180° corresponds to the luminous intensity angular distribution in a −90° to 90° range of the light distribution angle θ within the cross-section Pφ. In FIGS. 6 to 8, the lightest area (hereinafter referred to as a highlight area) represents the area in which the luminous intensity is the highest, and areas adjacent to the periphery of the highlight areas which are expressed darker than the highlight areas represent areas in which the luminous intensity is lower than that in the highlight areas. However, the lightness/darkness within the circle and the size of the luminous intensity do not necessarily have a constant relationship (such as the darker the area, the lower the luminous intensity) across the entire circle, but at the very least, areas in which the lightness/darkness is different correspond to areas in which the luminous intensity is different. The uniformity of the luminous intensity distribution in the direction around the optical axis q on the hemispherical surface shown in FIGS. 6 to 8 directly reflects the uniformity of illuminance in the direction around the optical axis q on the flat surface to be irradiated such as a floor surface.

FIG. 6 shows the light distribution properties of an illuminator that does not include a light distribution control member as a comparative example. In this case, a unimodal luminous intensity angular distribution is generated having a peak value of luminous intensity on the optical axis q (the center of the circle shown in FIG. 6). In such light distribution properties, only the area directly below the illuminator is bright, and it becomes rapidly darker towards the periphery. In the case of this comparative example, the illuminance is uniform in the direction around the optical axis q (direction around the circle's perimeter in FIG. 6).

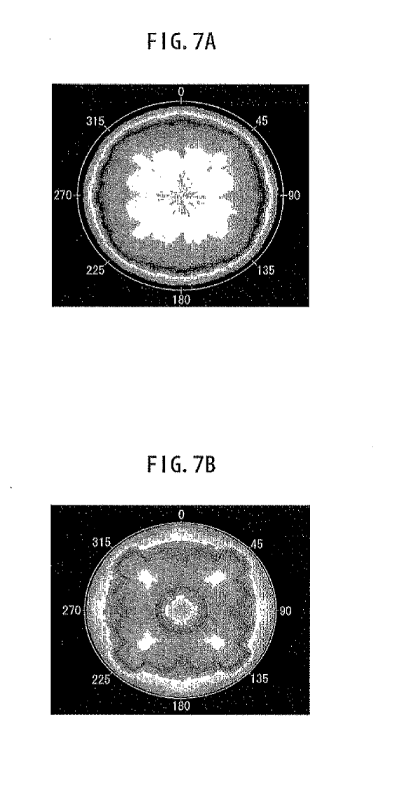

FIG. 7A shows the light distribution properties of an illuminator using a light distribution control member having a prism surface over which prisms made of four-sided truncated pyramids are tightly arranged (corresponding to the light distribution control member 30 shown in FIG. 2A) as an example of the present invention. FIG. 7B shows the light distribution properties of an illuminator using a light distribution control member having a prism surface over which prisms made of four-sided pyramids are tightly arranged (thus, there are no flat parts on the prism surface) as a comparative example.

In FIGS. 7A and 7B, the refractive index of the material forming the light distribution control members was 1.49, and the inclination angle of the inclined surfaces of the prisms was 52.5°. In the comparative example shown in FIG. 7B, the light distribution control member was arranged in a reverse prism sheet fashion as in the example of the present invention.

In the example of the present invention shown in FIG. 7A, batwing light distribution properties were realized, and with respect to a required angle θ_{R} of 22° (in this case, an ideal value of the relative intensity A/B on the optical axis is 80%), the relative intensity A/B on the optical axis was 80%, which matches the ideal value. On the other hand, in the comparative example shown in FIG. 7B, batwing light distribution properties were realized, but with respect to a required angle θ_{R} of 22°, the relative intensity A/B on the optical axis was 33%, and this was remarkably smaller than the ideal value of 80%. In other words, in the case of the comparative example shown in FIG. 7B, the illuminance on the surface to be irradiated exhibited non-uniformity in that the area directly below the illuminator was darker than the surrounding areas.

These results demonstrate that the luminous intensity on the optical axis q can be increased by using a light distribution control member in which flat parts are provided on the prism surface, compared to the case of using a light distribution control member including a prism surface that does not have flat parts, and thus it is possible to improve the uniformity of illuminance on the surface to be irradiated.

In addition, in the luminous intensity distribution of the comparative example, as shown in FIG. 7B, a prominent non-uniformity having four-fold rotational symmetry relative to the direction around the optical axis q was generated. In contrast, from FIG. 7A, it can be seen that in the example of the present invention using a light distribution control member in which flat parts are provided on the prism surface, the non-uniformity of the luminous intensity distribution around the optical axis q was improved.

However, in FIG. 7A, although a non-uniformity having four-fold rotational symmetry relative to the direction around the optical axis q can be seen, the non-uniformity is improved to an extent that the relatively bright areas (the highlight areas and the surrounding areas thereof) have a rounded quadrilateral shape. Therefore, this example of the present invention can be used as a suitable illuminator for illuminating a quadrilateral surface to be irradiated (for example, the floor surface of a general indoor space), utilizing the light distribution properties described above. Further, if the illuminator of this example is used as one lighting unit, and a plurality of lighting units are adjacently arranged to constitute a multi-unit illuminator having an overall wide emitting surface, the portions in which the illumination lights from the lighting units overlap each other can be reduced, and thus a surface to be irradiated having a relatively wide surface area can be efficiently lighted.

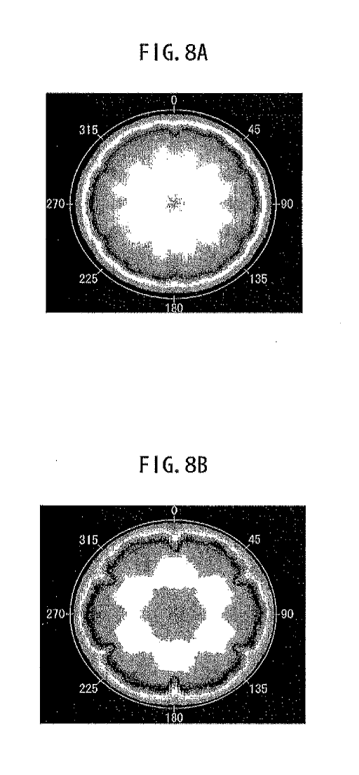

FIG. 8A shows the light distribution properties of an illuminator using a light distribution control member having a prism surface over which prisms made of three-sided truncated pyramids are tightly arranged (corresponding to the light distribution control member 60 shown in FIG. 3A) as an example of the present invention. FIG. 8B shows the light distribution properties of an illuminator using a light distribution control member having a prism surface over which prisms made of three-sided pyramids are tightly arranged (thus, there are no flat parts on the prism surface) as a comparative example.

In FIGS. 8A and 8B, the refractive index of the material forming the light distribution control members was 1.49, and the inclination angle of the inclined surfaces of the prisms was 52.5°. In the comparative example shown in FIG. 8B, the light distribution control member was arranged in a reverse prism sheet fashion as in the example of the present invention.

In the example of the present invention shown in FIG. 8A, batwing light distribution properties were realized, and with respect to a required angle θ_{R} of 23° (in this case, an ideal value of the relative intensity A/B on the optical axis is 78%), the relative intensity A/B on the optical axis was 78%, which matches the ideal value. On the other hand, in the comparative example shown in FIG. 8B, batwing light distribution properties were realized, but with respect to a required angle θ_{R} of 23°, the relative intensity A/B on the optical axis was 69%, and this was smaller than the ideal value of 78%. In other words, in the case of the comparative example shown in FIG. 8B, the illuminance on the surface to be irradiated exhibited non-uniformity in that the area directly below the illuminator was darker than the surrounding areas, similarly to the comparative example of FIG. 7B.

Similarly to the example described above referring to FIG. 7, these results demonstrate that the luminous intensity on the optical axis q can be increased by using a light distribution control member in which flat parts are provided on the prism surface, compared to the case of using a light distribution control member including a prism surface that does not have flat parts, and thus it is possible to improve the uniformity of illuminance on the surface to be irradiated.

In addition, in the luminous intensity distribution of the comparative example, as shown in FIG. 8B, a prominent non-uniformity having six-fold rotational symmetry relative to the direction around the optical axis q was generated. In contrast, from FIG. 8A, it can be seen that in the example of the present invention using a light distribution control member in which flat parts are provided on the prism surface, the non-uniformity of the luminous intensity distribution around the optical axis q was improved. Further, in the luminous intensity distribution of this example, compared to the example shown in FIG. 7A, the uniformity around the optical axis q was even further improved by increasing the rotational symmetry from four fold to six fold.

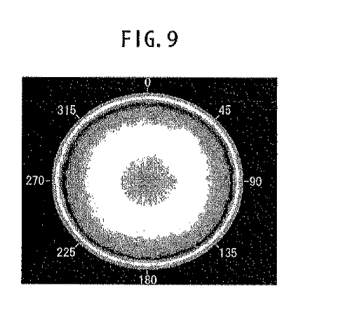

FIG. 9 shows the light distribution properties of an illuminator using a light distribution control member having a prism surface on which prisms made of circular cones are arranged with gaps therebetween (in this case, the flat parts of the prism surface are constituted by the flat surfaces formed around the prisms) as an example of the present invention. In this example, batwing light distribution properties were realized, and with respect to a required angle θ_{R} of 25° (in this case, an ideal value of the relative intensity A/B on the optical axis is 76%), the relative intensity A/B on the optical axis was 75%, which approximately matches the ideal value. From FIG. 9, it can be seen that the luminance distribution of the example was even further improved in the uniformity around the optical axis q, compared to the examples shown in FIGS. 7A and 8A.

1. An illuminator comprising a light source unit having an emitting surface for emitting light, and a light distribution control member having a prism surface comprising a plurality of prisms that have inclined surfaces and are arranged in a plane for two-dimensionally controlling light distribution of light emitted from the light source unit, wherein the prism surface has flat parts.

2. An illuminator according to claim 1, wherein the light distribution control member is arranged such that the prism surface is adapted to face the emitting surface of the light source unit.

3. An illuminator according to claim 2, wherein an inclination angle of the inclined surfaces of the prisms is greater than 42° but less than 45°, or is greater than 47° but less than 55°.

4. An illuminator according to claim 1, wherein the prisms are made of four-sided pyramids or four-sided truncated pyramids.

5. An illuminator in which a plurality of lighting units consisting of the illuminator according to claim 4 are adjacently arranged.

6. An illuminator according to claim 1, wherein the prisms are made of three-sided pyramids or three-sided truncated pyramids.

7. An illuminator according to claim 1, wherein the prisms are made of circular cones or circular truncated cones.

8. An illuminator according to claim 1, wherein the light source unit includes a light guiding plate and light sources arranged on side edge surfaces of the light guiding plate.
